(19) United States
(12) Patent Application Publication
(10) Pub. No.: US 2009/0012631 A1
(43) Pub. Date: Jan. 8, 2009

(54) Automation safety life cycle

(76) Inventor: Dale Fuller, The Woodlands, TX (US)

Correspondence Address: LAW OFFICE OF DAVID MCEWING, P.O. BOX 231324, HOUSTON, TX, 77023, US

(21) Appl. No.: 11/825,040

(22) Filed: Jul. 3, 2007

(51) Int. Cl. G05B 15/00

(52) U.S. Cl. 700/1

(57) ABSTRACT

The system subject of disclosure includes computer software inputted with machine readable data into a CPU that sequentially combines and integrates multiple activities and processes of a production or processing facility. The steps or functions performed by the software include but are not limited to performing control rationalization, process hazard analysis and layer of protection analysis. The software also evaluates safety requirement specifications, and safety, environmental and financial integrity levels. Finally, the software performs alarm rationalization, alarm management, process safety management and creating an integrated comprehensive machine readable facility database that can be used over the life of the facility.

### BACKGROUND OF INVENTION

1. Field of Use

The invention includes a cause and effect matrix view and user interface for integrity level fault tree calculations. The invention also includes comprehensive process safety management.

2. Related Technology

Existing practice utilizes safety information furnished separately by individual vendors without integration to the whole of the facility. The content and mode of this information assemble by this fractured practice has varied with each vendor. This creates multiple user interfaces with limited search capability beyond the data recorded by a single vendor, i.e., there has been no integration of databases.

### SUMMARY OF INVENTION

Included within the scope of the invention is computer software that when inputted with machine readable data into a CPU can sequentially combine and integrate multiple activities and processes of a production or processing facility. The steps or functions performed by the software may include but are not limited to performing control rationalization, process hazard analysis and layer of protection analysis. The software may also evaluate safety requirement specifications, and safety, environmental and financial integrity levels. Finally, the software may perform alarm rationalization, alarm management, process safety management and creating an integrated comprehensive machine readable facility database that can be used over the life of the facility.

### SUMMARY OF DRAWINGS

The accompanying drawings, which are incorporated by reference and constitute part of the specification, illustrate preferred embodiments of the invention. These drawings, together with the summary of invention given above and the detailed description of the preferred embodiments given below serve to explain the principles of the invention.

FIG. 1 comprises a chart that shows an overview of the invention wherein various inputs are received at the top of the chart and are variously handled by the control rationalization software module, the process hazard analysis module, the safety requirement specification module, the integrity level function module, alarm rationalization and alarm management modules.

FIG. 2 illustrates the control rationalization module wherein the inputs are control narratives and/or indices tag unit where the information is either embedded or inputted. The information is processed by the control rationalization software module and ultimately recorded by the process safety management software module.

FIG. 3 illustrates the process hazard analysis module with the flow and processing of information from operating procedures, P&ID tags and assign nodes to the process hazard analysis (PHA) software module and ultimately to the level of protection analysis (LOPA). Nodes are groups selected from the P&ID for convenience of analysis.

FIG. 4 illustrates the safety requirement specification module including flow and processing of information beginning with the cause and effect matrices embedded to the safety requirement specification software module. Also inputted is data from the process narratives and operating narratives wherein the operating trip scenarios are defined.

FIG. 5 illustrates the integrity level module with the flow and processing of information beginning with failure data that is either hand written or machine readable. The information is received by a failure data software sub-module. The data flow also includes calculation of the integrity level in a cause and effect matrix.

FIG. 6 illustrates the alarm rationalization module including flow and processing of information starting with P&ID tag type alarms which are inputted into an alarm rationalization software module

FIG. 7 illustrates the alarm management module including flow and processing of information beginning with information from a decentralized control system database which is automatically inputted into a master alarm table comparison software sub-module. Information is communicated to a master alarm table and to an alarm rational module and process hazard analysis.

FIG. 8 illustrates the process hazard analysis and software module including flow and processing of information beginning with the input of data from construction, training and approvals, to a management of change software sub-module.

FIG. 9 comprises a legend of symbols to FIGS. 1 through 8.

FIG. 10 illustrates the components of the lifecycle information pillars.

### DETAILED DESCRIPTION OF INVENTION

The invention pertains to process safety management at process and production facilities and the comprehensive collection of CPU readable data. Process safety management (hereinafter “PSM”) pertains to any activity or combination of activities including use, storage, manufacturing or handling of hazardous chemicals. The invention can be utilized by the facility design/builder, and existing and future operators. The information can be used in retrofits of the plant or in accident investigations. The information can be used to evaluate plant performance. The process safety management (PSM) of this invention includes as a goal a comprehensive and integrated evaluation and management of safety spanning multiple process areas.

One embodiment of the invention includes an integrated, comprehensive, full lifecycle, searchable database of the facility with regard to facility and operation. The facility database is not fractured among the data provided by different vendors. The data may be maintained in a single format at a single user interface for ease of retrieval. The comprehensive and integrated database of facility constitute elements, i.e., process and safety equipment and operational history allows for planning and analysis of faults that is otherwise possible. Fault analysis and cause and effect analysis is no longer a matter of guess work, but can be refined by actual data of operation and performance.

The system utilizes a user interface. A well known example of a user interface for a CPU is a graphical user interface (GUI). The database can be updated or revised to reflect changes or expansion of the facility or for equipment replacement.

Included within the automated embodiment of the invention is computer software that when inputted with machine readable data into a CPU sequentially combines and integrates multiple processes of a production or processing facility (hereinafter “processing facility” or “process facility”). The plant equipment is hereinafter termed “process equipment”. This facilitates the comprehensive evaluation of safety management. The steps or functions performed by the software include performing control rationalization (hereinafter “CR”), process hazard analysis (hereinafter “PHA”) and layer of protection analysis (hereinafter “LOPA”). The software also evaluates safety requirement specifications (hereinafter “SRS”), and safety, environmental and financial integrity levels. The software performs alarm rationalization (hereinafter “AR”), alarm management (hereinafter “AM”), process safety management (hereinafter “PSM”) and creating a machine readable facility database. The software can perform cause and effect analysis and integrity level fault tree calculations.

The control rationalization pertains to equipment relocation, facility preparation, process relocation, risk management and cost estimates. Process hazard analysis is a tool of safety engineers, including the assessment of risk made by combining the severity of consequences with the likelihood of occurrence in a matrix. A hazard may be defined as a “Condition, event, or circumstance that could lead to or contribute to an unplanned or undesirable event.” Seldom does a single hazard cause an accident. More often, an accident occurs as the result of a sequence of causes. A hazard analysis will consider system state, for example operating environment, as well as failures or malfunctions.

While in some cases safety risk can be eliminated, in most cases a certain degree of safety risk must be accepted. In order to quantify expected accident costs before the fact, the potential consequences of an accident, and the probability of occurrence must be considered. Assessment of risk is made by combining the severity of consequence with the likelihood of occurrence in a matrix. Risks that fall into the “unacceptable” category (e.g., high severity and high probability) must be mitigated by some means to reduce the level of safety risk. The layer of protection (LOPA) is closely aligned with a PHA. The safety requirement specifications have the goal of development of specification for safety instrumented systems design. The SRS evolves through the entire life of the process plant. This document is a requirement of the PSM.

The alarm rationalization involves development and maintaining an alarm philosophy, ownership, controls on the creation of new alarms, alarm change management, alarm prioritization, alarm definitions, operating procedures, training and maintenance and testing. Alarm management similarly includes the usability problem of too many alarms, i.e., an alarm flood. Alarm management is particularly useful in an environment controlled by an operator using a distributed control system. Alarm management is viewed as an ongoing task.

Fault tree analysis involves identifying an undesired effect that is taken as the root (top event) of a tree of logic. Then each situation that could cause that effect is added to the tree as a series of logic expressions. On goal is to identify the shortest route through the tree between an event and an initiator in the tree.

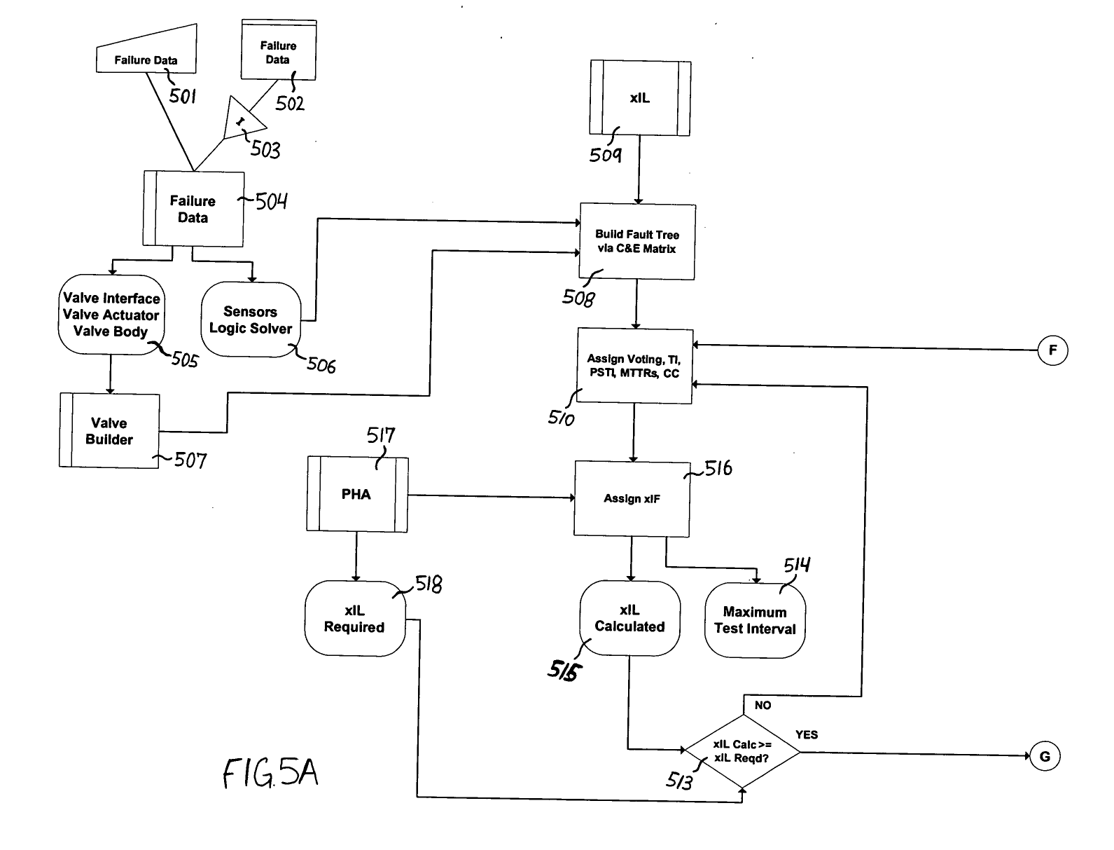

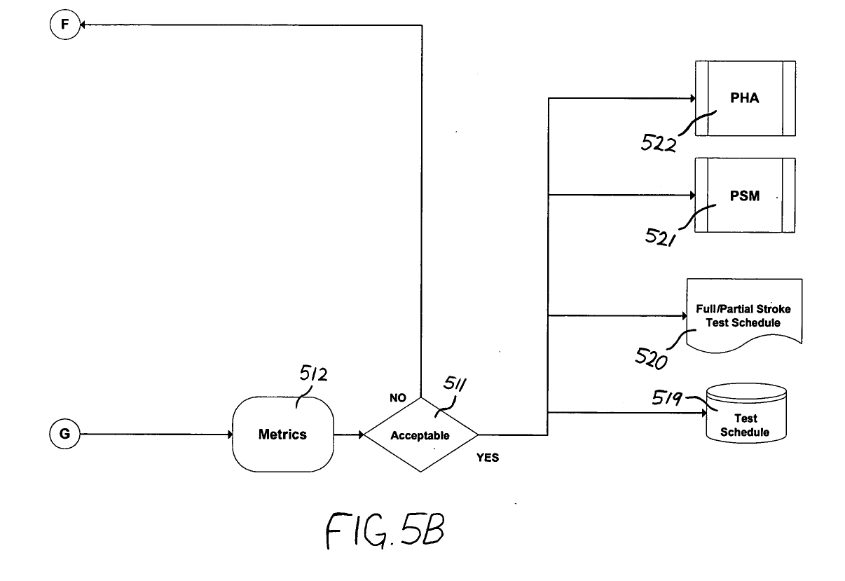

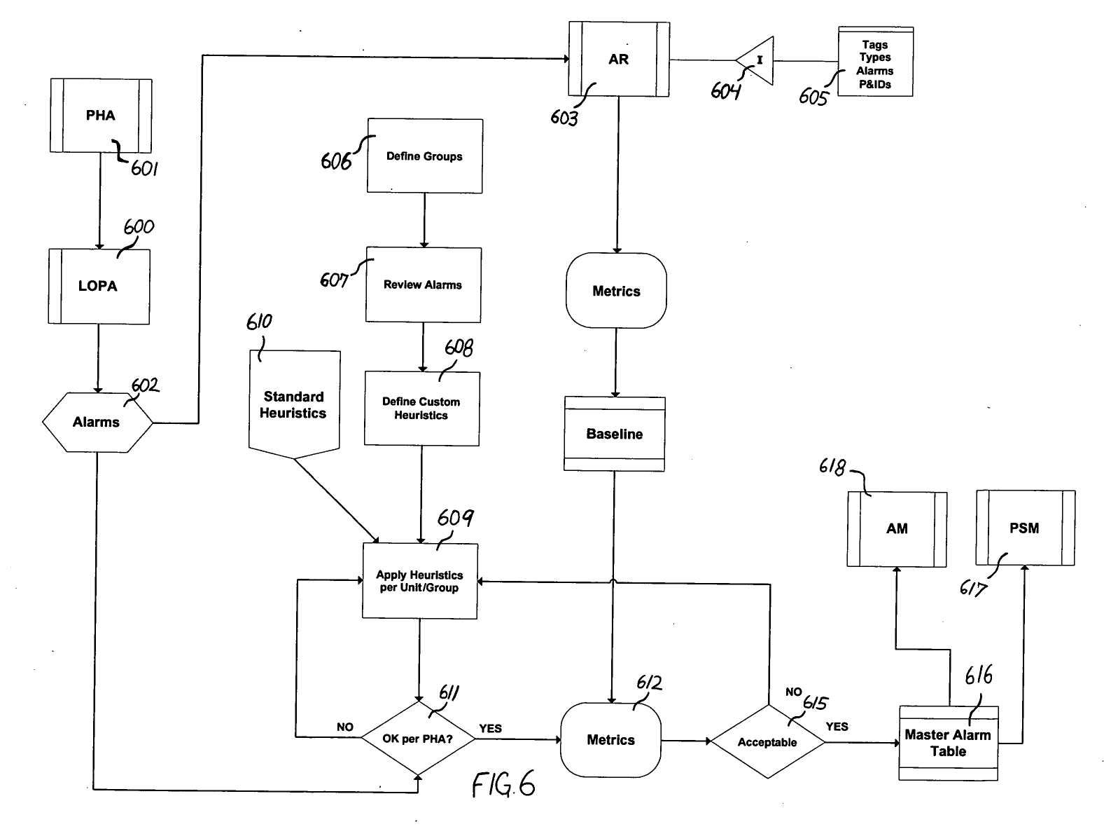

Elements of the invention can include a cause-and-effect matrix view (hereinafter “C&E”) for the plant and user interface for integrity level fault tree calculations. Reference FIG. 5. (For example, a valve builder may compile and communicate to the plant valve failure data and valve proof test and partial stroke test schedule generation. (A partial stroke test is movement of valve actuator at command.) Also included is optimization of proof test schedules vis-à-vis plant turnaround schedules and integration of plant specific process hazard analysis (PHA) and layer of protection analysis (LOPA) safeguards with integrity function probability calculation (hereinafter “xIL”). For example, the probability may be a function of one of several factors, e.g., safety integrity function, (hereinafter “SIF”), environmental integrity function (hereinafter “EIF”), and financial integrity function (hereinafter “FIF”). The invention can include integration of (i) PHA and LOPA safeguards with plant specific alarm rationalization (AR) and alarm management (AM) functions and (ii) process safety management with PHA/LOPA, integrity functions and alarm management. Reference is made to FIG. 6.

The software, which is included in the automated embodiment of the invention, utilizes a cause and effect matrix. This is a tool to evaluate all possible causes of a problem. It requires an accurate statement of the problem and a through listing of all possible causes. There can be weighting or ranking of potential causes. This feature is also termed hazard event matrix.

The software can also provide a complete view and recording of the processes and tasks with one interface program that manages the various vendors required for completion of the project. This can include equipment safety, design documents, information, construction documents and training documents.

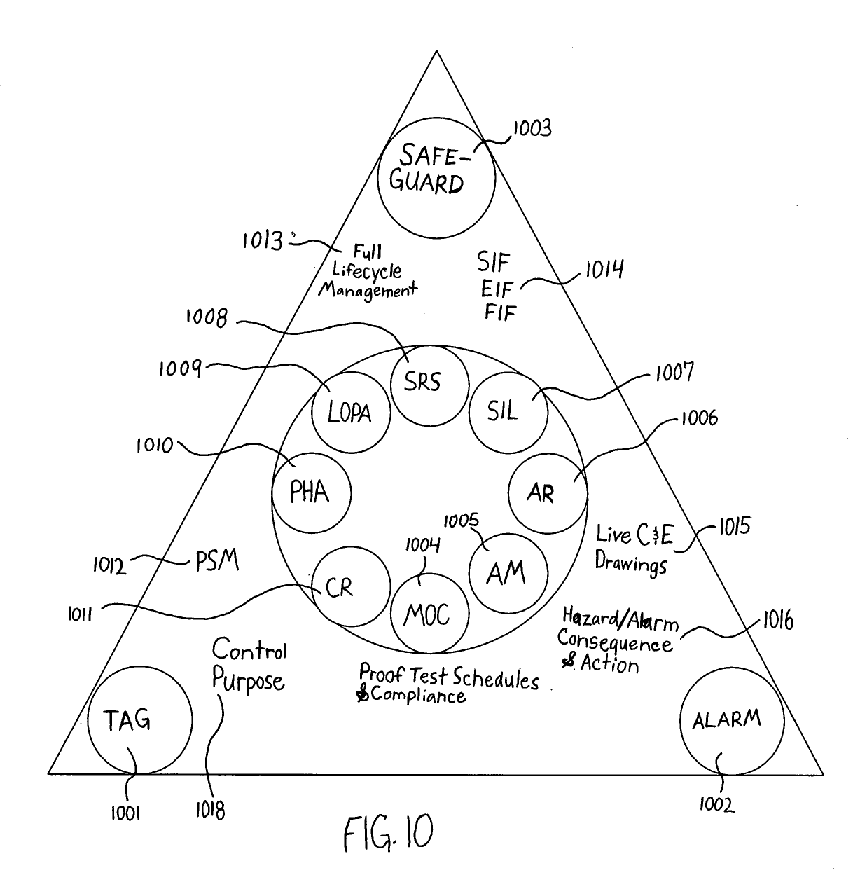

The Automated Safety Life Cycle system, illustrated in FIG. 10, and software of the invention utilizes information pillars including tags, i.e., equipment identifiers, alarms, i.e., devices used to alert of a process change, and a safeguards, i.e., full life cycle management. Other components include level of protection analysis (LOPA), safety requirements specification (SRS), safety integrity level (SIL), alarm rationalization (AR), alarm management (AM), management of change (MOC), control rationalization (CR) and process hazard analysis (PHA).

There are at least two cycles of a production or process plant. First there is the design phase. Items that can be included, but not as limitations, within this phase are control rationalization Justifying the need, placement and objects to be controlled). Another element of the design function is process hazard analysis, i.e., information gathering, analysis and documentation to identify hazards of a combined plant. Also included is a safety requirement specification (hereinafter “SRS”) developed to ensure that the critical control system is designed to meet the necessary technical requirements to prevent or minimize loss of production, damage to equipment or injury to personnel. The SRS serves as the basis for a conceptual design package. It is developed through the entire design effort. The SRS is also part of the process safety management (PSM).

Also included in the design phase is the safety integrity level verification. The safety integrity level (hereinafter “SIL”) is part of the SRS since it requires documentation of risk reduction allocated to each independent protection layer. The safety integrity level is the relative level of risk-reduction provided by a safety function or to specify a target level of risk reduction. An SIL is defined based upon a number of quantitative factors in combination with qualitative factors such as development process and safety life cycle management. The requirements for a given SIL are not consistent among all of the functional safety standards.

The design phase also includes alarm rationalization. Alarm rationalization (hereinafter “AR”) is actually a continuing step. The alarm rationalization is sometimes conducted after completion of the design phase. Preferably, the alarm rationalization is part of the earliest design phases with the output being a deliverable document at the end of the design phase.

Included in the operation phase, is alarm management (hereinafter “AM”). This includes, but is not limited to, the review of the controls and functionality of the alarms, alarm prioritization, alarm organization and presentation, alarm maintenance and testing.

Process safety management (hereinafter “PSM”) pertains to defined Highly Hazardous Chemicals and the handling or processing of these materials. The processing entity must have a written plan meeting agency rules.

In addition to the preceding paragraphs and the figures discussed below, the invention includes but is not limited to the following items:
Cause-and-Effect Matrix view and user interface, i.e., user computer interface, for Integrity Level Fault Tree calculations.
Valve Builder for compiling valve failure data.
Valve Proof Test and Partial Stroke Test Schedule generation. Optimization of Proof Test Schedules vis-a-vis turnaround schedules.
Integration of Process Hazard Analysis (PHA) and Layer of Protection Analysis (LOPA) Safeguards with Integrity Function probability calculation (xLI).
Integration of PHA and LOPA Safeguards with Alarm Rationalization (AR) and Alarm Management (AM) functions.
Integration of Process Safety Management with PHA/LOPA, Integrity Functions, and Alarm Management (AM).
An integrated, full-lifecycle, searchable database.

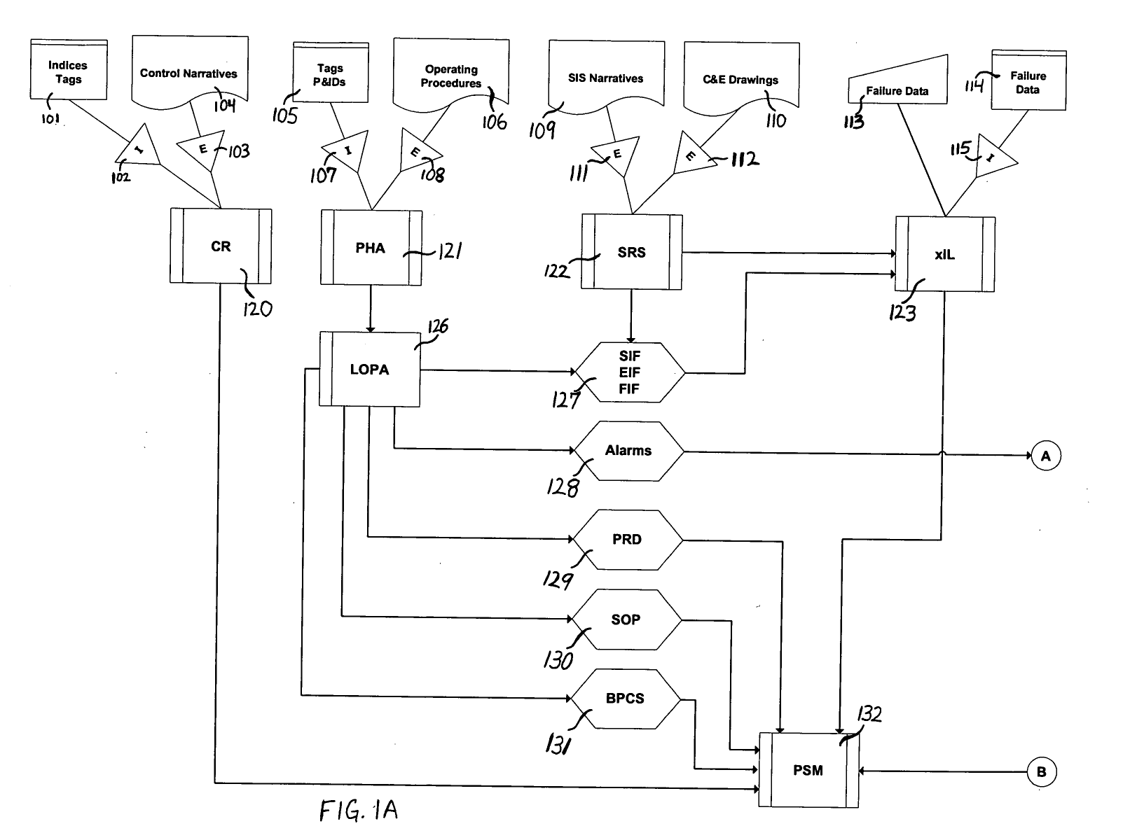

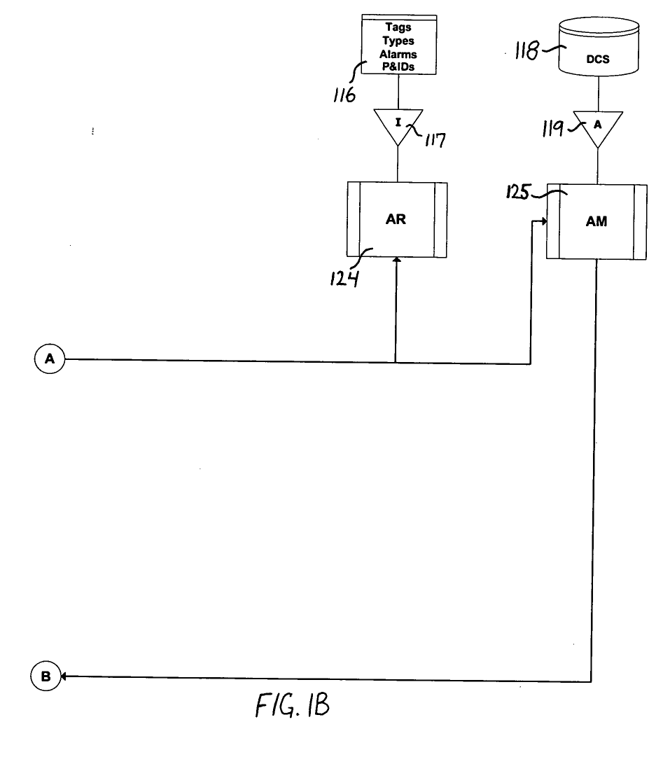

FIG. 1 illustrates an overview of one embodiment of the automated safety lifecycle software flow sheet. Illustrated is various information being inputted to software modules control rationalization (CR) 120, process hazard analysis (PHA) 121, safety requirements specification (SRS) 122, integrity level probability (xIL) 123, alarm rationalization (AR) 124, alarm management (AM) 125 and ultimately to the process safety management (PSM) module 132. The PSM module pertains to OSHA regulations intended to assure safe and healthy workplaces and contain requirements for the management of hazards associated with processes using highly hazardous chemicals.

Indices tags 101, (identifying specific equipment) and control narratives 104 are inputted 102, 103 to the control rationalization (CR) module 120. The CR module processes information including but not limited to equipment location, process system location, schedule development, risk management and procurement planning.

FIG. 1 (read with FIG. 10) further discloses the flow of information from tagged piping and instrumentation diagrams (P&IDs) 105 and operating procedures 106 inputted 107, 108 into the PHA 121 software module and then to the LOPA 126 sub-module. Data is then transferred to the following safeguards: the basic process control system (hereinafter “BPCS”) 131, standard operating procedure (SOP) 130, pressure relief device (hereinafter “PRD”) 129, alarms 128 and the safety integrity function, (hereinafter “SIF”), environmental integrity function (hereinafter “EIF”), and financial integrity function (hereinafter “FIF”) 127. The processed information is then transferred to the PSM software module 132.

FIG. 1 also illustrates safety integrity system (SIS) narratives 109 and cause & effect matrix drawings 110 inputted 111, 112 to the SRS 122 and then to the SIF/EIF/FIF safeguard 127 and to the integrity level probability (xIL) 123. Manually entered failure data 113 and computer inputted 115 failure data 114 is inputted into the xIL 123, the SRS 122 and the SIF/EIF/FIF safeguard 127. The processed information flows to the PSM 132 software module.

Computer inputted 117 data of tags, types, alarms and P&IDs 116 is entered into the alarm rationalization (AR) software module. The information then is transferred to the alarms safeguard 128 and then to the PSM software module. FIG. 1 also illustrates information from distributed control system databases 118 automatically inputted 119 into the alarm management software module. The processed information is then transmitted to the alarms safeguard 128 and to the PSM 132 software module.

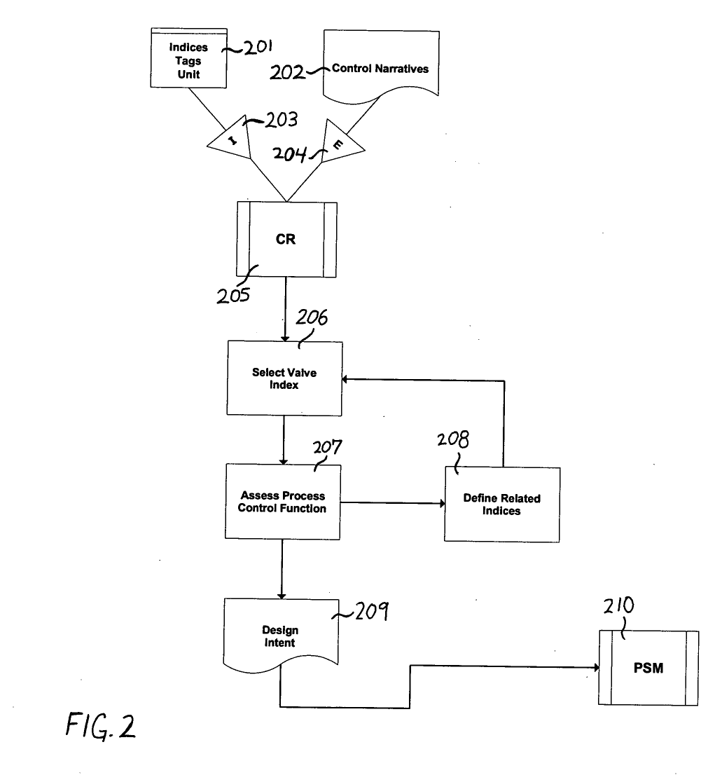

FIG. 2 illustrates the control rationalization (CR) module beginning with the indices tag units 201 inputted 203 and the control narrative document 202 embedded 204 into the CR 205. The information is then transferred to a select value index 206 wherein the information flows either directly to an assess process control function 207 or via define related indices 208. The information is transmitted to a design intent document 209 and then to the PSM 210.

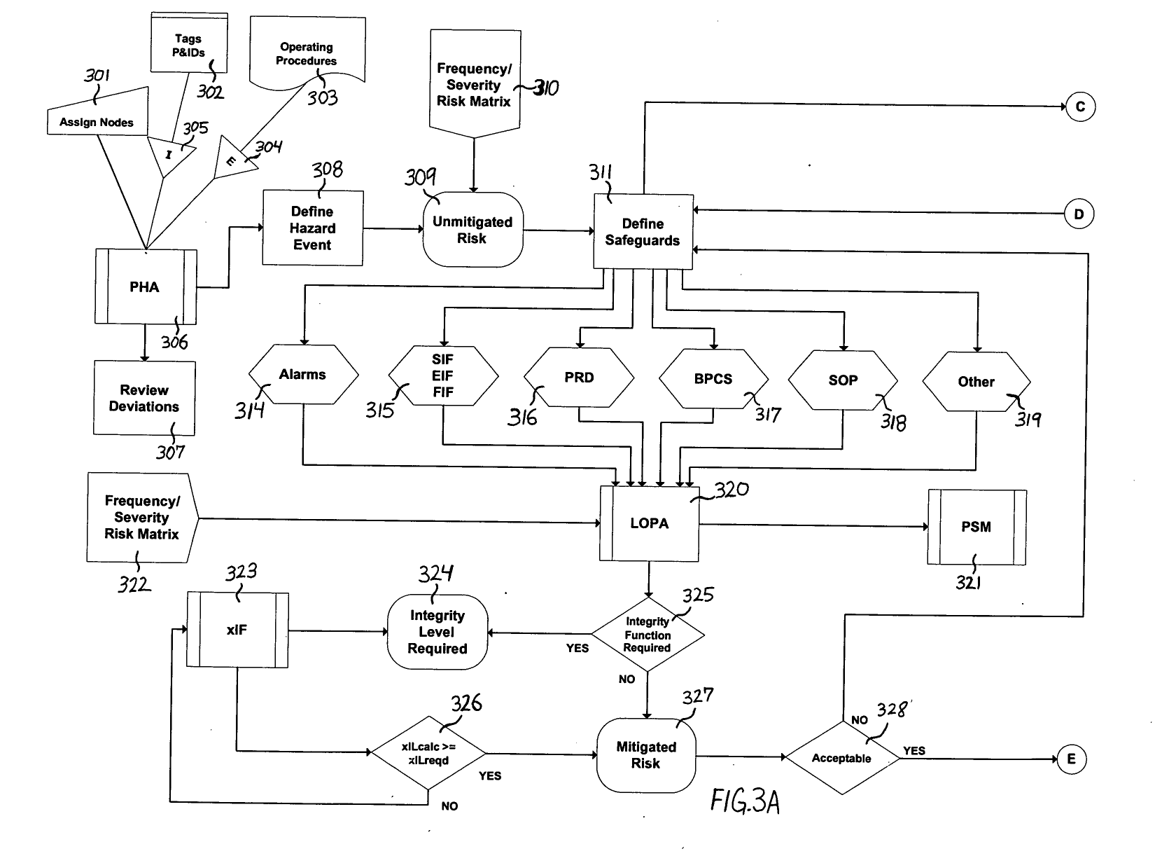

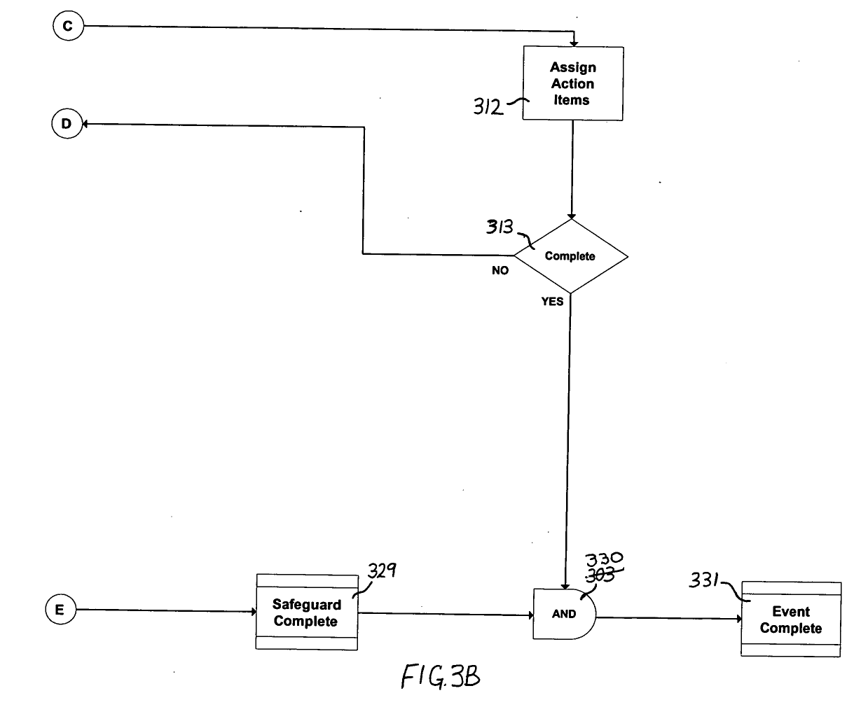

FIG. 3 illustrates the process hazards analysis module. The figure illustrates integration of process hazard analysis (PHA) 306 with the layer of protection analysis (LOPA) 320 safeguards and the integrity function probability calculation (xIL) 323.

Manual entry of assigned nodes 301 and inputting 305 of tags P&ID and embedding 304 operating procedures 303 documents into the PHA software module 306. Deviations are reviewed 307 and hazard events defined 308 and calculation made of whether it is an unmitigated risk 309 using a frequency/severity risk matrix 310. Nodes are groupings of components or equipment from a P&ID for convenience of analysis.

The safeguards are defined 311 comprising alarms 314, SIF/EIF/FIF 315, pressure relief device (PRD) 316 basic process control system (BPCS) 317 standard operating procedure (SOP) 318, and “other” 319. Information passes through the safeguards to the layer of protection analysis 320. From that step, information is evaluated by the process safety management software module 321 and by the frequency/severity risk matrix 322. The information is also processed through a decision point of whether an integrity function is required 325. If no, the information passes to the mitigated risk 327 and whether that risk is acceptable 328. If the risk is not acceptable, the data returns to the safeguards. If the response to the integrity function decision point is negative, there is a determination of the integrity level required 324 and evaluation of the data through the xIF software module. If the xIF calculation (whether SIF, EIF or FIF) exceeds the applicable xIF required 326, the information flow proceeds to step mitigation risk 327 and the decision point 328 of whether the risk is acceptable. If the response is yes, the safeguard is stated to be complete 329 and the event compete 331. At the safeguard step 311, information is processed to assign action items 312. A decision is made whether the action items are complete 313. If no, the process returns to the safeguards step. If the action items are complete, the process proceeds 330 and to event complete statement 331.

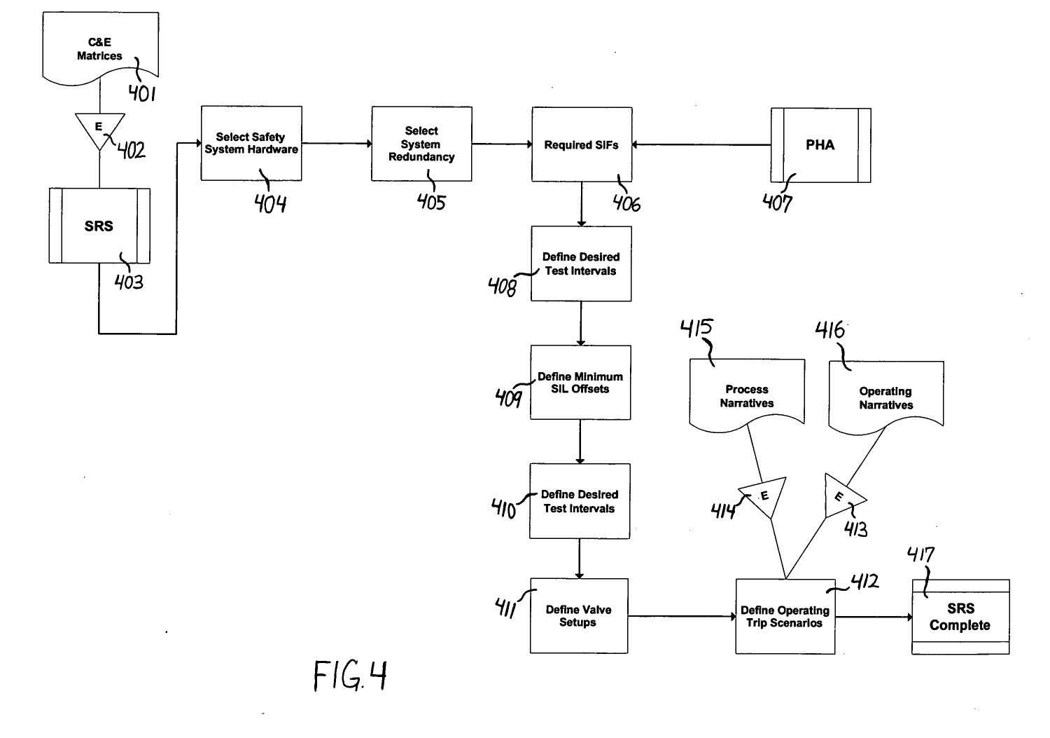

FIG. 4 illustrates the safety requirements specification module. Cause and effect matrices (C&E) 401 are embedded 402 in the safety requirement specification 403 software module. Based upon the evaluation of data, the safety system hardware is selected 404, the system redundancy is selected, the required safety integrity function 406, and desired test intervals defined 408. The information also flows from the safety integrity function to process hazard analysis software module 407.

The minimum SIL offsets are defined 409, the desired test intervals defined 410, and define valve setups 411. After the test intervals are defined, further data is embedded 414, 413 from process narratives 415 and operating narratives 416 to define the operating trip scenarios and the safety requirement specification (SRS) is stated to be complete 417.

FIG. 5 illustrates the integrity level module. The process begins with the manual entry of failure data 501 and inputted 503 failure data 502 to the software sub-module labeled failure data 504. Information is transmitted to a valve interface/valve actuator and valve body 505 and then to a valve builder software sub-module. The process next flows to the build fault tree via C&E matrix 508. Information is also transmitted from the failure data 504 to a sensor logic solver 506 and then to the build fault tree via C&E matrix 508. An additional input is the integrity level probability (xIL) 509. At the next step voting, test interval (TI), partial stroke test interval (PSTI), mean time to repair (MTTRs), common cause failure percent (CC) are assigned 510. The CC provides a floor (or ceiling) to failure calculations. The information flows through 2 paths. The next step of one path assigns the probability of integrity function 516 and then to calculation of the probability of integrity level 515 and the maximum test interval 514. There is next a decision point 513 wherein the calculated xIL is compared to the required xIL. If the calculated xIL does not exceed the required xIL, then the process can return to the assignment of voting, test interval (TI), partial stroke test interval (PSTI), mean time to repair (MTTR) common cause (CC) 510. If yes, the metrics are verified 512 and determination made of acceptability 511. If unacceptable, the process returns to assignment of voting, TI, PSTI, MTTRs, CC 510. If acceptable, the information is processed by the PHA module 522, the PSM module 521 and the full/partial stroke test schedule 520 and test schedule 519.

FIG. 6 illustrates the alarm rationalization module. The process begins the tags, types, alarms P&ID 605 inputted 604 to the alarm rationalization 603 software module. Data can flow to the alarm safeguard 602 and to the PHA 601. The LOPA is part of the PHA and is not shown. Information can also flow from the AR to metrics 614 and a baseline statement 613 to a separate set of metrics 612.

As a separate step, the alarms can be defined in groups 606 and reviewed 607. Custom heuristics are defined 608 and combined with standard heuristics 610 in applying heuristics per unit/group. If the applied heuristics 611 are acceptable, the data is passed to the metrics 612, etc. If not acceptable, the data is returned to the unit/group heuristics 609.

If the information is acceptable pursuant to the metrics, the information is stated in a master alarm table 616 and processed by the AM 618 and the PSM 617.

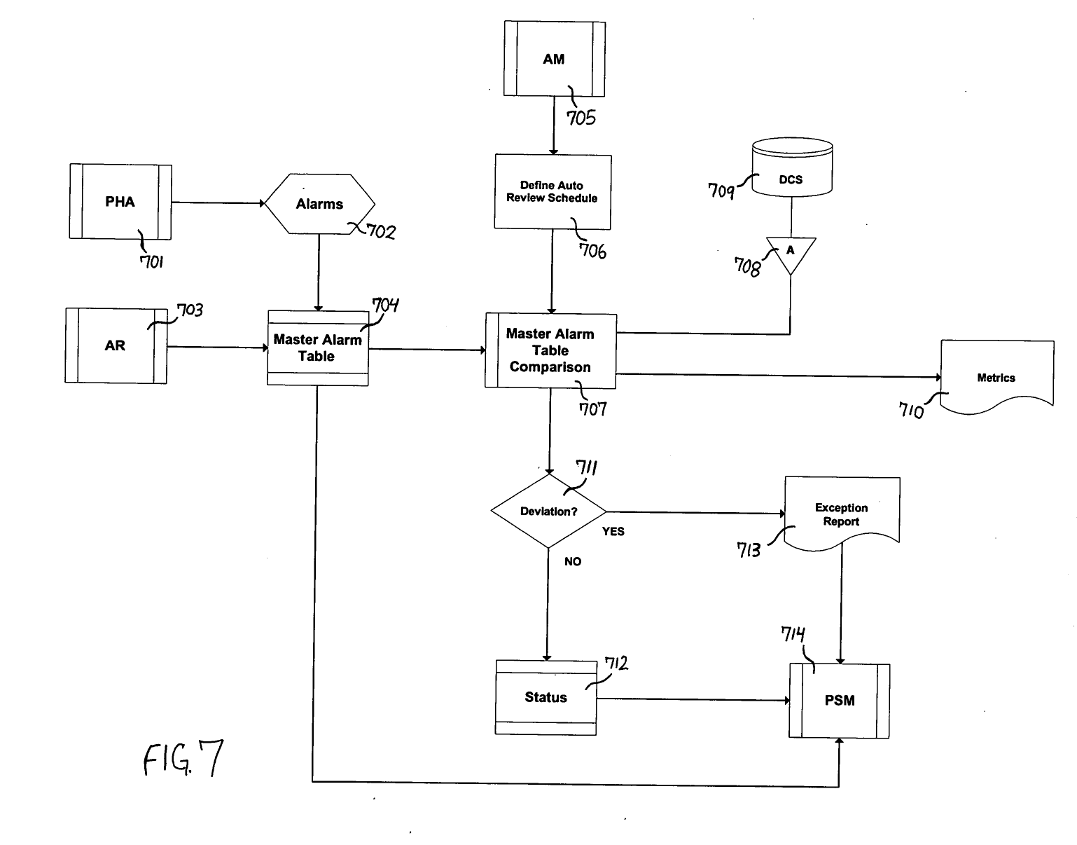

FIG. 7 illustrates the alarm management module. The module automatically 708 data from distributed control systems (DCS) 709 to the master alarm table comparison 707 sub-module. Additional data input is from the alarm manager (AM) 705 through the step 706 defining auto review schedule. Data is received from the process hazard analysis (PHA) software module 701 to the alarms safeguards 702 to the master alarm table 704 which also receives data from the alarm rationalization (AR) module 703. Data from these multiple sources is submitted to the master alarm table comparison 707. A comparison is made with metrics 710.

A decision point is made regarding whether there is a deviation 711. If yes, an exception report is created 713. If there is no deviation, a status statement 712 is created and the information is transferred to the PSM 714. Note that information is directly transferred to the PSM from the master alarm table 704 and from the exception report 713.

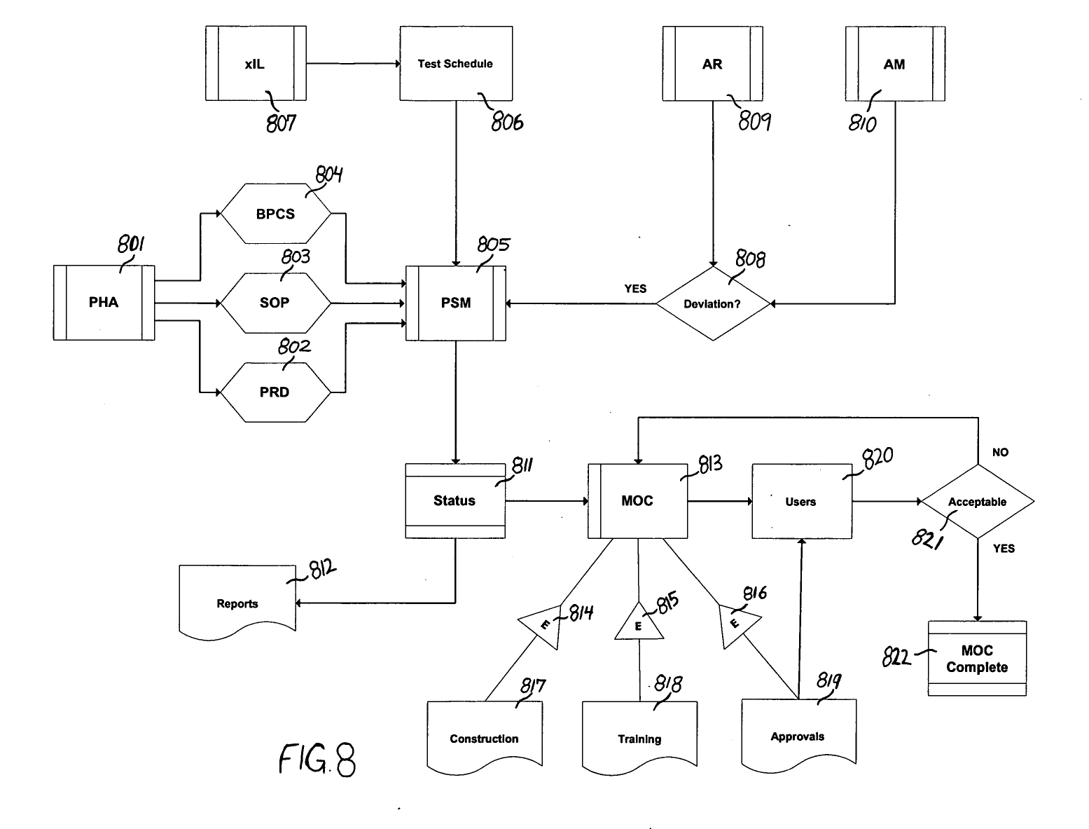

FIG. 8 illustrates the process safety module (PSM). The PSM 805 receives input from multiple sources including the process hazard analysis (PHA) 801 through the basic process control system (BPCS) 804, the SOP 803 and pressure relief device (PRD) 802. Input is also received from the probability of integrity level (xIL) 807 through the test schedule 806. Input is also provided from the alarm rationalization (AR) 809. If there is a deviation, data is submitted to the alarm management (AM) 810. It there is no deviation, then the data in submitted to the PSM.

Based upon data submitted to the PSM, a status statement is issued 811 and report issued 812. Further, depending upon the status statement, it may be necessary to change the system. Information is submitted to a management of change 813 software sub-module. The sub-module may receive embedded information from construction documents 817, training documents 818 and approval documents 819. There may be communication and input of information between the approval documents and users 820. The information processed by the management of change sub-module may be transferred to users 820 and to a decision point 821 of acceptability. If not acceptable, the process returns to the management of change sub-module. If acceptable, the process terminates with a statement of completed management of change 822.

HAZOP is an abbreviation for HAZard and OPerability analysis. Originally developed for use at manufacturing facilities such as oil refineries, offshore oil platforms, petrochemical and chemical plants, natural gas processing plants and power plants, its application has expanded to other areas as well. It is a systematic method for examining complex facilities or processes to find actual or potentially hazardous procedures and operations so that they may be eliminated or mitigated. HAZOP Studies are performed by a team consisting of plant operators, engineers, managers and others, some of whom should be intimately familiar with the facility being studied.

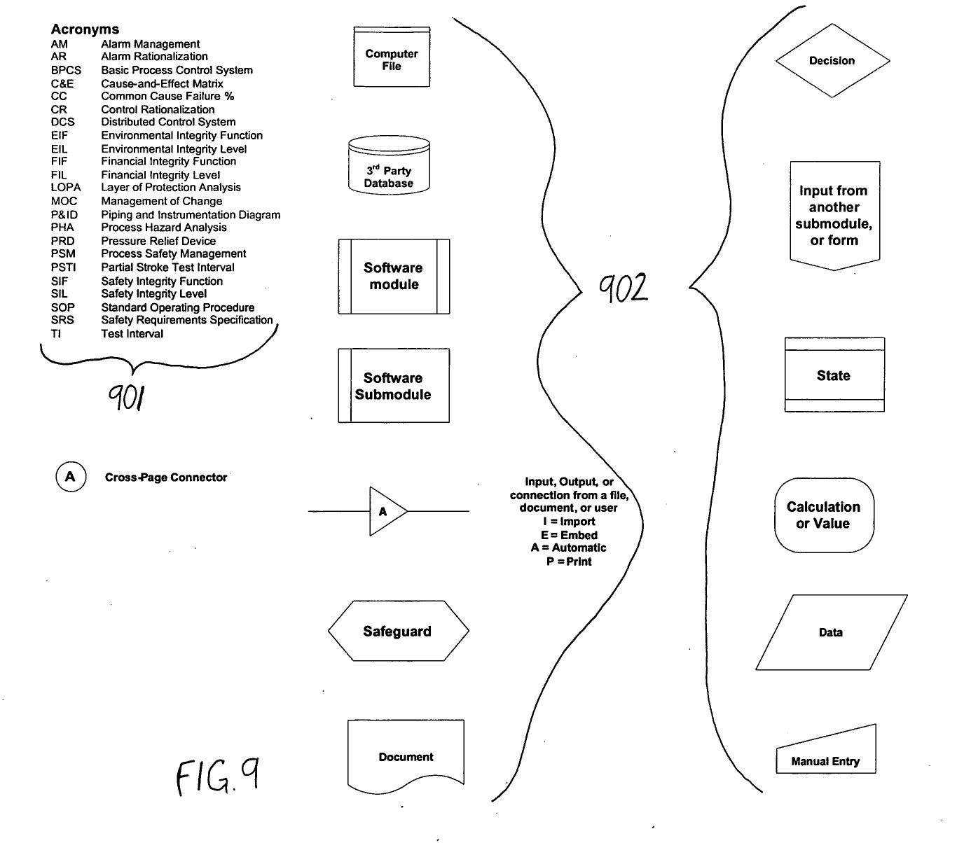

FIG. 9 contains a legend of abbreviations used in this disclosure 901 and symbols 902 used in the flow diagrams of FIGS. 1 through 8.

FIG. 10 illustrates the three pillars of the system comprising tags 1001 (equipment identifiers), alarms 1002 (alerting change in equipment or process condition) and safeguards 1003 (mitigating or preventing undesired conditions). Also illustrated within the system are management of change 1004, alarm management 1005, alarm rationalization 1006, safety integrity level 1007, safety requirement system 1008, layer of protection analysis 1009, process hazard analysis 1010, and control rationalization 1011. Other elements included within FIG. 10 are process safety management 1012, full lifecycle management 1013, safety integrity function, environmental integrity function, and financial integrity function 1014, live cause and effect drawings 1015, hazard/alarm consequence and action 1016, proof test schedules and compliance 1017, and control purpose 1018.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

While specific embodiments have been illustrated and described, numerous modifications are possible without departing from the spirit of the invention, and the scope of protection is only limited by the scope of the accompanying claims.

What I claim is:

1. Processing facility computer software that when inputted with machine readable data into a CPU creates a facility database that can be sequentially combined and integrated in multiple processes comprising:
(a) performing control rationalization;
(b) performing process hazard analysis;
(c) performing layer of protection analysis;
(d) evaluating safety requirement specifications;
(e) evaluating safety, environmental, or financial integrity levels;
(f) performing alarm rationalization;
(g) conducting alarm management; and
(h) performing process safety management.

2. A computerized system that sequentially combines and integrates multiple processes for the design, construction and startup of a processing facility comprising:
(a) control rationalization;
(b) process hazard analysis;
(c) layer of protection analysis;
(d) safety requirement specifications;
(e) safety, environmental, or financial integrity level verification;
(f) alarm rationalization;
(g) alarm management;
(h) process safety management; and
(i) a facility database.

3. The system of claim 2 further comprising using the facility database to evaluate facility operation and facility safety.

4. The control rationalization of claim 2 further comprising equipment location and equipment control location and recording into the facility database.

5. The process hazard analysis of claim 2 further comprising HAZOP analysis and checklists of federal regulatory requirements and recording information into the facility database.

6. The process hazard analysis of claim 5 further comprising checklists of federal regulatory requirements specific to chemical, petroleum, pulp and paper, or metal fabrication.

7. The safety requirement specification of claim 2 further comprising collection and recording of data through the design, construction and startup of the facility.

8. The safety integrity level verification of claim 2 further comprising assessment of impact of implementing safety functions and recording the information in the facility database.

9. The alarm rationalization procedure of claim 2 further comprising alarm management procedure development, development of alarm system metrics, benchmarking the existing alarm system, and identification and analysis of individual alarms and recording the information into the facility database.

10. The alarm management procedure of claim 2 further comprising alarm change management, alarm prioritization, alarm organization and training and recording information into the facility database.

11. The process safety management procedure of claim 2 further comprising the Occupational Health and Safety Administration Process Safety Management of Highly Hazardous Chemicals regulations.

12. The facility database of claim 2 further comprising of process and safety equipment capacities, performance information and maintenance information that is electronically searchable and readable for the full lifecycle of the facility.

13. The system of claim 2 further comprising using computer software to integrate the safety requirement for multiple processes of a processing facility.

14. A system for performing integrity level fault tree calculations comprising a computer interface, cause and effect matrix and integrity level probability.

15. The system of claim 14 further comprising inputting failure data into a failure module wherein a valve actuator or valve interface failure is calculated and a sensor logic solver is calculated.

16. An automated safety life cycle system comprising integration of process hazard analysis and layer of protection analysis safeguards with at least one integrity function probability calculation and a database of process facility performance.

17. The system of claim 16 further comprising integration of alarm rationalization and alarm management functions.

18. An automated safety life cycle system for process plant safety comprising integration of process safety management with a safety requirement system, safety integrity level, process hazard analysis, layer of protection analysis safeguards and alarm management.

19. An automated safety life cycle system for process plant safety comprising creating a cause and effect matrix using a database of process facility operation and process equipment information with a computer assisted user interface.

20. The system of claim 19 further comprising using a user computer interface and recorded data of process and safety facility operation to create at least one integrity level.

21. The system of claim 19 further comprising creating a fault tree.
